(19) United States
(12) Patent Application Publication
(10) Pub. No.: US 2019/0035037 A1
(43) Pub. Date: Jan. 31, 2019

(54) VIRTUAL RESTAURANT SYSTEM

(71) Applicants: Arnold Chase, West Hartford, CT (US); William Chase, West Hartford, CT (US)

(72) Inventors: Arnold Chase, West Hartford, CT (US); William Chase, West Hartford, CT (US)

(21) Appl. No.: 16/044,663

(22) Filed: Jul. 25, 2018

Related U.S. Application Data
(60) Provisional application No. 62/536,690, filed on Jul. 25, 2017.

(51) Int. Cl. G06Q 50/12; G06Q 30/06; G06Q 10/08

(52) U.S. Cl. CPC G06Q 50/12; G06Q 10/0833; G06Q 10/087; G06Q 30/0633

(57) ABSTRACT

The present application is directed to a virtual restaurant system (VRS) providing centrally managed ordering, production and delivery of branded food items normally only available from different restaurant menus. By using the VRS, a customer may select food items as if from different restaurant menus in a single order, the selected food items may be simultaneously prepared at a single food production facility and the selected food items may be delivered to the customer in a single delivery. The VRS includes a computer ordering system that is accessible by customers via VRS applications installed on computing devices. The VRS further includes one or more central kitchen facilities located in different geographic areas. The VRS may also include food delivery equipment installed on delivery vehicles.

### CROSS REFERENCE TO RELATED APPLICATIONS

This application claims the benefit under 35 U.S.C. § 119(e) of U.S. Provisional Application No. 62/536,690, filed on Jul. 25, 2017, which is hereby incorporated by reference in its entirety.

### TECHNICAL FIELD

The present application generally relates to coordinated food ordering, food preparation and food delivery services.

### BACKGROUND OF THE INVENTION

Restaurants have evolved over the years, moving away from their original “eat-in” concept by adding various forms of “take-out” service for its customers: initially with “take-out” counter areas, then adding “drive-through” windows, and presently trying to accommodate the growing number of third-party pickup and delivery services. As these new services expand, they increasingly tax a restaurant's infrastructure and labor resources, thus challenging a restaurant's ability to provide a desired level of food quality and service for their “legacy” customers. As a result of the increasing need to accommodate these new delivery channels, the overall quality of service at restaurants may decline. Further, the increasingly important “third party” delivery channels have difficulty in not only making timely pickups (i.e., arriving to pick up an order when it is not yet ready, or experiencing delays in picking up an order that has already been completed and is left out for an extended period of time), but also being able to provide the same quality level (e.g., serving temperature) as an in-restaurant dining, or a drive-through takeout experience offers. Additionally, when a customer requests the delivery of freshly prepared food from a particular restaurant for example, via a delivery service, a designated vehicle is assigned for the sole task of driving to the specific restaurant location associated with the desired food, picking it up, and then delivering the food to a particular delivery location. As such, the vehicle is wholly allocated to just one particular pickup and delivery. Simultaneous orders from additional restaurants for the same customer would multiply the delivery charges, greatly increase the time required for delivery, and would not result in any additional operating efficiency. Additionally, the current method for picking up and delivering cooked or refrigerated meals merely attempts to limit the food temperature losses by the use of insulated containers. Because of the energy inefficiencies and size of conventional mobile heating or refrigeration equipment, these means are typically not practical to be utilized. Unlike any of the current third-party delivery systems, VRS uses a unique driver/delivery vehicle aggregation system that only assigns an order and delivery instructions to the driver/delivery vehicle at the time food items are picked up for delivery.

### SUMMARY OF THE INVENTION

Provided is a Virtual Restaurant System (VRS) designed to optimize the “end to end” approach of off-site ordering, production and delivery of “restaurant” food, while at the same time freeing up resources at traditional restaurant locations. The VRS consists of a unique food ordering system, food production system, and food delivery system, which work together in a unified way to expand the number of menu items available to a customer, improve the efficiency of producing those food items selected by the customer, and improve the efficiency and efficacy of delivering food items selected by the customer in a optimized serving condition. With the VRS, there will no longer be a need for a customer that simultaneously desires the items from the menus and locations of more than one restaurant to either hire separate delivery services to pick up the desired items from each different restaurant or have a single delivery service sequentially pick up the desired items from each different restaurant location before finally delivering the consolidated items to the customer. For example, if there are ten people at a location who each wish to order items provided by different restaurants and wish to have the collection of orders from the different restaurants delivered to the location at the same time, it would be impractical to use present food order and delivery systems and methods for a variety of reasons. By utilizing the VRS, however, said order example could be accommodated simply and routinely, resulting in a single delivery of all of the various menu choices, thereby reducing delivery cost, increasing speed of delivery and improving arrival temperatures compared to any current food delivery method. In the VRS, a single ordering system may allow selection of items from a variety of different restaurant menus, yet a single food production facility may produce all of the food items available from the variety of different restaurant menus and combine items ordered from the different restaurant menus into a single delivery. While the VRS would be initially configured for full human participation in the production and delivery of the aforementioned food items, the system is inherently capable of transitioning step by step into a fully automated food production and autonomous vehicle delivery operation. Additionally, delivery may be accomplished by specialized VRS delivery equipment that constantly heats and/or cools the ordered items utilizing a unique energy efficient configuration, or by conventional delivery means. Despite the title of the present application, the same system components are also capable of alternatively being used for the ordering and delivery of temperature sensitive grocery items as well.

In one embodiment of the present application, a Virtual Restaurant System (VRS) for providing centralized food ordering, food preparation and food delivery for various restaurants, includes a plurality of central kitchen facilities and a Computerized Ordering System (COS) in communication with the central kitchen facilities and a plurality of VRS applications installed on remote computing devices. Each of the central kitchen facilities is adapted to produce a specified menu of food items. Further, each of the central kitchen facilities includes a plurality of kitchens, where each of the kitchens in each of the central kitchen facilities produces a corresponding branded subset of food items in the specified menu. The COS receives a plurality of food orders via the VRS applications and assigns each of the food orders a unique food order ID, where each of the food orders includes a delivery location and a selection of food items from the specified menu. For each of the food orders, the COS selects one of the central kitchen facilities based on the delivery location. For each of the food orders, the COS transmits the food order and its corresponding food order ID to the selected central kitchen facility. The selected central kitchen facility receives the food order and orders each of the selection of food items to be produced by its corresponding kitchen and labeled with the food order ID. The selected central kitchen facility sorts through the food produced by the kitchens and groups the food items belonging to the same food order together based on the labeled food order ID. The selected central kitchen facility moves completed food orders to an order-loading zone where they can be loaded into delivery vehicles for delivery.

In some of the embodiments of the above VRS, the selected central kitchen facility communicates to a delivery vehicle the delivery location and the food order ID for the food order to be delivered.

In some of the embodiments of the above VRS, the selected central kitchen facility monitors the requested delivery locations of food orders and uses a Delivery Optimizing Algorithm to group together multiple food orders that are ready for loading so that they can be sequentially delivered by a single delivery vehicle. The Delivery Optimizing Algorithm determines a sequential order and a delivery route for delivering the multiple food orders that are grouped together for delivery.

In some of the embodiments of the above VRS, the selected central kitchen facility monitors the requested delivery locations of food orders and the number of delivery vehicles waiting in queue at any given time. In order to balance the number of outstanding orders with the number of available delivery vehicles, the VRS uses a Delivery Optimizing Algorithm that will dynamically assign multiple sequential delivery stops to each delivery vehicle when necessary in order to optimize the delivery capability of each Central Kitchen Facility at any given time.

In some of the embodiments of the above VRS, the selected central kitchen facility coordinates delivery vehicles to queue up in a single continuous line at the order-loading zone for loading food orders in a sequential manner.

In some of the embodiments of the above VRS, the selected central kitchen facility coordinates delivery vehicles to initially queue up in a continuous line, but then directs individual vehicles to individual loading ports in the order-loading zone where a number of delivery vehicles are simultaneously loaded and assigned delivery information.

In some of the embodiments of the above VRS, the selected central kitchen facility communicates to a delivery vehicle the sequential order and the delivery route for delivering the multiple food orders that are grouped together for delivery.

In some of the embodiments of the above VRS, the COS sends a food order status notification via the VRS Application to notify a customer about the pending delivery of a completed food order.

In some of the embodiments of the above VRS, the COS sends a food order verification via the VRS Application to verify that a customer is waiting at the delivery location for delivery of the food order.

In some of the embodiments of the above VRS, the VRS further comprises food delivery equipment installed on delivery vehicles. The food delivery equipment includes a temperature controlled storage system with a plurality of storage compartments and one or more heating/cooling thermal units. Both thermal sides of the one or more heating/cooling thermal units are used to refrigerate a first group of the plurality of storage compartments and heat a second group of the plurality of storage compartments.

In some of the embodiments of the above VRS, the VRS further comprises food delivery equipment installed on delivery vehicles. The food delivery equipment includes a storage system with a plurality of storage compartments that are electronically locked/unlocked and monitored. The storage system electronically monitors whether storage compartments are storing food items for a food order. Upon arrival at a delivery location associated with the food order, the storage system unlocks the storage compartments storing food items associated with the food order and monitors the opening of the unlocked storage compartments to ensure that the food items associated with the food order are retrieved.

In some of the embodiments of the above VRS, the storage system provides a visual and/or audible alert that an unlocked storage compartment containing food items associated with the food order to be retrieved has not been opened.

In some of the embodiments of the above VRS, each of the storage compartments includes an indicator light that is adapted to light up to indicate that the storage compartment is unlocked and contains food items associated with the food order to be retrieved.

In some of the embodiments of the above VRS, each of the storage compartments has a storage compartment ID to facilitate loading and unloading of food items and to track storage and delivery of food items.

In some of the embodiments of the above VRS, the VRS further comprises food delivery equipment installed on delivery vehicles. The food delivery equipment includes a doorbell system interface module or other home access interface module configured to interact with a doorbell system or other home access system to announce the delivery of a food order.

In one embodiment of the present application, a method for providing centralized food ordering, food preparation and food delivery for various restaurants, includes a Computer Ordering System (COS) communicating with a customer via a Virtual Restaurant System (VRS) application installed on a remote computing device. The COS automatically receives and/or requests a customer location and/or a delivery location via the VRS application. The COS delivers a selected menu/food order form via the VRS Application, optimized and customized for the Central Kitchen Facility that would be producing the order for a specific customer. The COS receives a food order via the VRS Application, the food order includes food selections from the selected menu/food order, requested delivery location and requested delivery date/time. The COS assigns a unique food order ID to the food order and transmits the food order ID to the customer via the VRS Application. The COS transmits the food order and the food order ID to the appropriate central kitchen facility including a plurality of kitchens, where each of the plurality of kitchens produces different branded food items from the selected menu/food order form. The selected central kitchen facility orders each of the branded food selections from the food order to be produced by its corresponding branded kitchen and labeled with the food order ID. The central kitchen facility sorts through the food items produced by the kitchens and groups the food items belonging to the same food order together based on the labeled food order ID. The central kitchen facility moves the completed food order to an order-loading zone where it can be loaded into a delivery vehicle for delivery.

In some of the embodiments of the above method, the selected menu/food order form is selected from a plurality of menu/food order forms. Each of the plurality of menu/food order forms corresponds to a specific central kitchen facility with a defined service area. The selected menu/food order form is selected based on whether the customer location and/or delivery location is located in the defined service area of the central kitchen facility.

In some of the embodiments of the above method, the central kitchen facility communicates to the delivery vehicle the delivery location and the food order ID for the food order to be delivered at the time of delivery vehicle loading.

In some of the embodiments of the above method, the central kitchen facility monitors the requested delivery locations of food orders and the number of delivery vehicles waiting in queue at any given time. In order to balance the number of outstanding orders with the number of available delivery vehicles, the central kitchen facility uses a Delivery Optimizing Algorithm that will dynamically assign multiple sequential delivery stops to each delivery vehicle when necessary in order to optimize the delivery capability of each central kitchen facility at any given time

In some of the embodiments of the above method, the central kitchen facility coordinates delivery vehicles to queue up in a single continuous line at an order-loading zone for loading food orders in a sequential manner.

In some of the embodiments of the above method, the central kitchen facility coordinates delivery vehicles to initially queue up in a continuous line, but then directs individual vehicles to individual loading ports in an order-loading zone where a number of delivery vehicles are simultaneously loaded and assigned delivery information.

In some of the embodiments of the above method, the central kitchen facility monitors the delivery locations of completed food orders and uses a Delivery Optimizing Algorithm to group together multiple food orders that are ready for loading so that they can be delivered by a single delivery vehicle.

In some of the embodiments of the above method, the Delivery Optimizing Algorithm determines a sequential order and a delivery route for delivering the multiple food orders that are grouped together for delivery.

In some of the embodiments of the above method, the central kitchen facility communicates to the delivery vehicle the sequential order and the delivery route for delivering the multiple food orders that are grouped together for delivery.

In some of the embodiments of the above method, the COS sends a food order status notification via the VRS Application to notify the customer about the pending delivery of a completed food order.

In some of the embodiments of the above method, the COS sends a food order verification via the VRS Application to verify that the customer is waiting at the delivery location for delivery of the food order.

In some of the embodiments of the above method, the COS sends a food order verification via the VRS Application to verify that the customer is waiting at the delivery location for delivery of the food order, and in the event one or more customers fail to affirm that they are waiting for their order, the COS algorithm would re-order the delivery sequence to temporarily bypass those non-responding locations in favor of the responding locations.

### BRIEF DESCRIPTION OF THE DRAWINGS

The foregoing summary, as well as the following detailed description, is better understood when read in conjunction with the appended drawings. For the purpose of illustrating the invention, exemplary embodiments are shown in the drawings, it being understood, however, that the present application is not limited to the specific embodiments disclosed. In the drawings:

FIG. 1 shows a schematic diagram of an exemplary Virtual Restaurant System (VRS);

FIG. 2 show an exemplary flow diagram for the operation of the exemplary VRS of FIG. 1;

FIG. 3 shows a schematic diagram of exemplary delivery-vehicle equipment of the exemplary VRS of FIG. 1;

FIG. 4 shows another schematic diagram of the exemplary delivery-vehicle equipment of FIG. 3; and

FIG. 5 shows yet another schematic diagram of the exemplary delivery-vehicle equipment of FIG. 3.

### DETAILED DESCRIPTION OF EMBODIMENTS OF THE INVENTION

Before the various exemplary embodiments are described in further detail, it is to be understood that the present invention is not limited to the particular embodiments described. It is also to be understood that the terminology used herein is for the purpose of describing particular embodiments only, and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

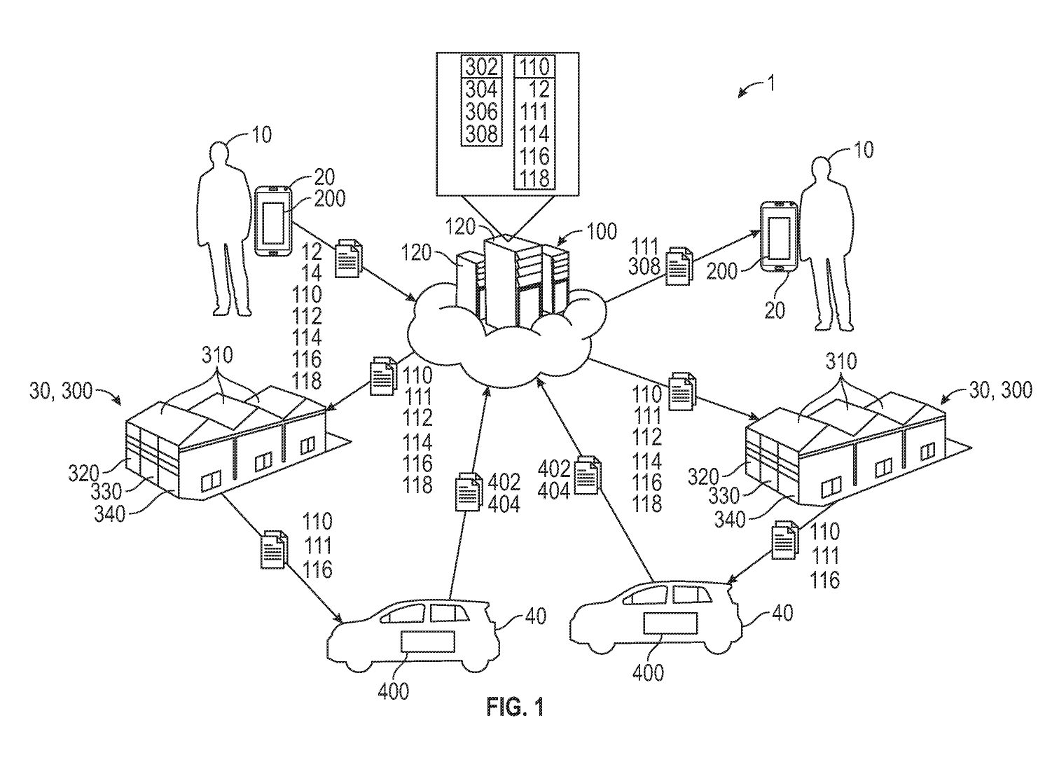

The present application is directed to a Virtual Restaurant System (VRS) providing centrally managed ordering, production and delivery of food items available from different restaurant menus. By using the VRS, a customer may select any food items from any different restaurant menus in a single order, the selected food items may be simultaneously prepared at a single food production facility and the selected food items may be delivered to the customer in a single delivery. As shown in FIG. 1, Virtual Restaurant System (VRS) 1 comprises a Computer Ordering System 100 that is accessible by customers 10 via VRS Applications 200 installed on computing devices 20. VRS 1 further includes one or more Central Kitchen Facilities 300 located in different geographic areas 30. VRS 1 may also include Food Delivery Equipment 400 installed on delivery vehicles 40.

Each Central Kitchen Facility 300 includes a plurality of separate kitchens 310 corresponding to different restaurant entities (e.g., restaurants, restaurant chains, restaurant groups, etc.). Separate, individual kitchens 310 corresponding to different restaurant entities are co-located in a single Central Kitchen Facility 300 physically adjacent to each other, but operate completely independently. The plurality of kitchens 310 at a given Central Kitchen Facility 300 are adapted to produce food items for different menus corresponding to different restaurant entities (e.g., restaurants, restaurant chains, restaurant groups, etc.). Accordingly, a given Central Kitchen Facility 300 is able to offer a composite menu that is an aggregation of all the food items available on the individual menus served by the plurality of kitchens 310, which are all available for selection by a customer in a single order from the Central Kitchen Facility 300.

As shown in FIG. 1, Computer Ordering System 100 includes one or more computer servers 120 in a centralized or distributed computing architecture. The functions of computer server 120 described herein may be implemented using computer applications comprising computer program code stored in a computer-readable medium that is executed by a computer processor. The functions of computer server 120 described herein may also be implemented in programmable hardware devices such as field programmable gate arrays, programmable array logic, programmable logic devices or the like. Further, functions of computer server 120 described herein may be implemented using some combination of computer program(s) executed by a computer processor and programmable hardware devices. Thus, computer server 120 of the present application comprises suitable computer hardware and software for performing the desired functions and are not limited to any specific combination of hardware and software.

The executable computer program code may comprise one or more physical or logical blocks of computer instructions, which may be organized as an object, procedure, process or function. For example, the executable computer program code may be distributed over several different code partitions or segments, among different programs, and across several devices. Accordingly, the executable computer program need not be physically located together, but may comprise separate instructions stored in different locations which, when joined logically together, comprise the computer application and achieve the stated purpose for the computer application.

Computer server 120 stores and maintains facility records 302 for each Central Kitchen Facility 300, including facility location 304, facility service area 306 and menu/food order form 308. Computer server 120 of Computer Ordering System 100 communicates with VRS Applications 200 installed on computing devices 20 to deliver menus/food order forms 308 corresponding to different Central Kitchen Facilities 300 and receive food orders 110 from customers 10. Computer Ordering System 100 receives food orders 110 from customers 10 via VRS Applications 200 installed on computing devices 20. Computer Ordering System 100 receives from VRS Applications 200 installed on computing devices 20 a unique user ID 12 associated with each food order 110 and food order information 112 associated with each food order 110. Food order information 112 may include food selections 114, requested delivery location 116 and requested delivery date/time 118.

Computer Ordering System 100 communicates with VRS Applications 200 via communication links that are established by means of suitable communication protocols (e.g., BLUETOOTH®, WI-FI®, ZIGBEE®, Ethernet, SAP®, SAS®, ATP, GSM, TCP/IP, etc.) and are, at least in part, established wirelessly. VRS Application 200 is embodied in a set of computer executable instructions stored in a non-transitory computer-readable medium, which are executed by a processor of the computing device 20 to provide customers 10 access to Computer Ordering System 100 to place food orders 110. Computing device 20 may be any suitable device (e.g., PC, laptop, tablet, smartphone, etc.) for executing VRS Application 200 to perform the functions described herein, and is preferably, a mobile computing device (e.g., tablet, smartphone, etc.).

Upon initiation of VRS Application 200 on a computing device 20 by a customer 10, Computer Ordering System 100 automatically receives and/or requests customer ID 12, customer location 14 and/or delivery location. Based on received customer location 14 and/or requested delivery location 116, Computer Ordering System 100 delivers a selected menu/food order form 308 to customer 10 via VRS Application 200 on computing device 20. The menu/food order form 308 delivered to customer 10 via VRS Application 200 corresponds to a selected Central Kitchen Facility 300 with a service area 306 that includes the customer location 14 and/or delivery location 116. In the event that there are multiple Central Kitchen Facilities 300 with services areas 306 that include the customer location 14 and/or delivery location 116, Computer Ordering System 100 may give customer 10 the option to select via VRS Application 200 one of the menus/food order forms 308 corresponding to the different Central Kitchen Facilities 300.

The menu/food order form 308 delivered to customer 10 via VRS Application 200 is a unified ordering system that combines menu offerings from differently branded restaurants into a unified “point of purchase” via VRS Application 200 Based on received customer location 14 and/or requested delivery location 116, Computer Ordering System 100 delivers a selected menu/food order form 308 to customer 10 via VRS Application 200 on computing device 20. A Central Kitchen facility 300 in a certain service area 306 may offer different restaurants' menus compared to another Central Kitchen facility 300 in a different service area 306. To the customer, it would appear as if all of the different restaurants' menus offered by the Central Kitchen facility 300 in a certain service area 306 were merged into a combined menu. Further, any items on the combined menu could be placed as part of a single order 110, rather than separate orders from different restaurant menus. Since only a single order 110 is placed, only a single delivery vehicle 40 is needed to fulfill an order comprising food items from different restaurant menus, rather than multiple delivery vehicles picking up and delivering food items from different restaurants. Another completely novel aspect of VRS 1 is that it also allows customers to order from, and get delivery from, restaurants that have no physical retail presence in a service area.

Customer 10 uses menu/food order form 308 presented via VRS Application 200 to provide food order information 112 (e.g., food selections 114, requested delivery location 116 and requested delivery date/time 118) and complete a food order 110. Once customer 10 completes a food order 110 via VRS Application 200, Computer Ordering System 100 receives food order 110 including food order information 112 and assigns food order 110 a food order ID 111. Computer Ordering System 100 sends customer 10, via VRS Application 200, food order ID 111 corresponding to the placed food order 110. Computer Ordering System 100 sends the selected Central Kitchen Facility 300 food order 110 including food order information 112 (e.g., food selections 114, requested delivery location 116 and requested delivery date/time 118) and food order ID 111. Computer server 120 stores and maintains food orders 110, including customer ID 12, food order ID 111 and food order information 112 (e.g., food selections 114, delivery location 116 and delivery date/time 118).

Computer Ordering System 100 communicates with Central Kitchen Facilities 300 via communication links that are established by means of suitable communication protocols (e.g., BLUETOOTH®, WI-FI®, ZIGBEE®, Ethernet, SAP®, SAS®, ATP, GSM, TCP/IP, etc.). Each Central Kitchen Facility 300 includes a plurality of separate kitchens 310, a facility computer server 320, a labeling system 330 and a sorting system 340, which communicate with one another via communication links that are established by means of suitable communication protocols (e.g., BLUETOOTH®, WI-FI®, ZIGBEE®, Ethernet, SAP®, SAS®, ATP, GSM, TCP/IP, etc.). Each individual kitchen 310 may be a specialized version of a corresponding “traditional restaurant” kitchen, which utilizes personnel, branded foodstuffs and cooking methods to produce food items in a corresponding restaurant menu for delivery orders. Each Central Kitchen Facility 300 operates solely for the purpose of producing branded meals, which may be identical to what would be produced by a corresponding “traditional” restaurant location, for fulfilling food delivery orders. Each Central Kitchen Facility 300 has no retail “point of presence,” no traditional restaurant/identifying signage, no access to the public, no seating, no on-premises order takers, no cashiers, no traditional retail “take-out” windows, etc. The sole purpose of a Central Kitchen Facility 300 is to generate branded food to fulfill food delivery orders received by Computer Ordering System 100 via VRS Applications 200. Thus, Central Kitchen Facilities 300 are specifically designed and purposefully used exclusively for specialized (i.e., non-publicly accessible) food production output.

Computer Ordering System 100 communicates with facility computer server 320 of Central Kitchen Facility 300 to transmit food orders 110 including food order information 112 (e.g., food selections 114, requested delivery location 116 and requested delivery date/time 118) and food order ID 111. Facility computer server 320 analyzes all of the food items 114 in a received food order 110 and instructs the corresponding kitchens 310 in Central Kitchen Facility 300 to simultaneously produce the food items 114 in food order 110. For example, if food items 114 in a food order 110 were selected from menus corresponding to different kitchens 310 (i.e., different restaurant entities), each ordered item 114 and associated food order ID 111 would be electronically transmitted for production to their respective kitchens 310 co-located in Central Kitchen Facility 300. Each kitchen 310 that is ordered to produce a food item 114 associated with a food order 110 produces the food item 114 and has the packaging electronically marked and/or tagged with the food item 114 and food order ID 111 (e.g., using labeling system 330), and then outputs the electronically marked and/or tagged food item 114 to a sorting system 340 controlled by facility computer server 320 of Central Kitchen Facility 300. Facility computer server 320 directs the sorting system 340 to first aggregate all of the food items 114 included in a specific order 110, and then directs the completed order 110 to an order-loading zone in Central Kitchen Facility 300.

Facility computer server 320 of Central Kitchen Facility 300 communicates with delivery vehicles 40 to ensure that delivery vehicles 40 are available to pick-up and deliver orders 110 from Central Kitchen Facility 300. Facility computer server 320 communicates with delivery vehicles 40 via communication links that are established by means of suitable communication protocols (e.g., BLUETOOTH®, WI-FI®, ZIGBEE®, Ethernet, SAP®, SAS®, ATP, GSM, TCP/IP, etc.) and are, at least in part, established wirelessly. For example, facility computer server 320 may pre-position delivery vehicles 40 in a queue so that a delivery vehicle 40 is continuously available to pick up one or more orders 110 from the order pickup location or loading area at Central Kitchen Facility 300. When a delivery vehicle 40 reaches the order-loading zone in Central Kitchen Facility 300, the delivery vehicle 40 is loaded with one or more food orders 110 and is given the food order IDs 111 and delivery location(s) 116 for the one or more orders 110. Delivery vehicles 40 may be either specialized VRS vehicles or “third-party” vehicles, and may be either driven or autonomous in nature.

Facility computer server 320 of Central Kitchen Facility 300 continually monitors the delivery locations 116 for all pending orders 110 and uses a Delivery Optimizing Algorithm to group food orders 110 that are ready for loading so that they can be delivered by a single delivery vehicle 40 on a multi-leg trip. Delivery Optimizing Algorithm determines a sequential order and a delivery route for delivering multiple food orders 110 that are grouped together for delivery by a single delivery vehicle. The number of orders aggregated for a single delivery trip may be dynamically adjusted by the Delivery Optimizing Algorithm executed by facility computer server 320 depending on numbers of orders 110 in the system, the proximity of delivery locations 116, the type of delivery vehicle available, the type of food product ordered, weather conditions, traffic conditions or other factors. Facility computer server 320 may communicate with third-party delivery vehicles 40 that wish to be pre-positioned in the queue a real-time indication of expected wait time for an order to be loaded.

As part of VRS 1, before a delivery vehicle 40 leaves Central Kitchen Facility 300 to a delivery location 116 with an order 110, Computer Ordering System 100 may transmit a food order delivery status notification 402 via the VRS Application 200, mobile phone text message or other method to let the customer 10 know of a pending delivery. Optionally, Computer Ordering System 100 would have the capability to text, email, communicate via the VRS Application 200, or call the customer 10 to verify that someone was actually at the delivery location 116 and was ready to receive the delivered order 110. By using the VRS Application 200, a customer 10 is also be able to change the delivery location 116 within a pre-determined alternate delivery radius.

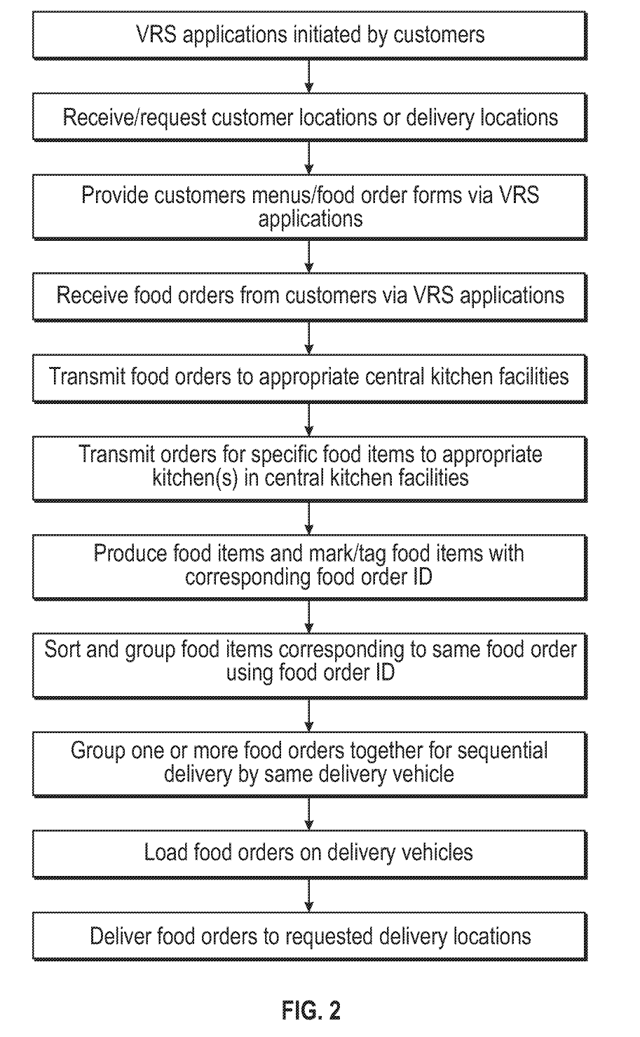

FIG. 2 flowchart depicting some steps of the operation of VRS 1 as discussed above. Customers 10 access VRS 1 using VRS Applications 200 installed on computing devices 20. When customers 10 initiate VRS Applications 200, Computer Ordering System 100 automatically receives and/or requests customer ID 12, customer locations 14 and/or delivery locations 116. Based on received customer physical locations 14 and/or requested delivery locations 116, Computer Ordering System 100 delivers selected menu/food order forms 308 to customers 10 via VRS Application 200 on computing device 20. The menu/food order forms 308 delivered to customers 10 via VRS Application 200 correspond to a selected Central Kitchen Facility 300 with a service area 306 that includes the customer location 14 and/or delivery location 116.

Customers 10 use menu/food order forms 308 presented via VRS Applications 200 to provide food order information 112 (e.g., food selections 114, requested delivery locations 116 and requested delivery dates/times 118) and complete a food orders 110. Once customers 10 complete food orders 110 via VRS Applications 200, Computer Ordering System 100 receives food orders 110 including food order information 112 and assigns food orders 110 corresponding unique food order IDs 111. Computer Ordering System 100 sends customers 10, via VRS Applications 200, food order IDs 111 corresponding to their placed food orders 110. Computer Ordering System 100 sends the selected Central Kitchen Facilities 300 food orders 110 including food order information 112 (e.g., food selections 114, requested delivery locations 116 and requested delivery dates/times 118) and food order IDs 111.

Computer Ordering System 100 communicates with facility computer servers 320 of Central Kitchen Facilities 300 to transmit food orders 110 including food order information 112 (e.g., food selections 114, requested delivery locations 116 and requested delivery dates/times 118) and food order IDs 111. Facility computer servers 320 analyze all of the food items 114 in received food orders 110 and instruct the corresponding kitchens 310 in Central Kitchen Facilities 300 to simultaneously produce the food items 114 in food orders 110. For example, if food items 114 in a food order 110 were selected from menus corresponding to different kitchens 310 (i.e., different restaurant entities), each ordered item 114 and associated food order ID 111 would be electronically transmitted for production to their respective kitchens 310 co-located in a Central Kitchen Facility 300. Each kitchen 310 that is ordered to produce a food item 114 associated with a food order 110 produces the food item 114 and has the packaging electronically marked and/or tagged with the food item 114 and food order ID 111 (e.g., using labeling system 330), and then outputs the electronically marked and/or tagged food item 114 to a sorting system 340 controlled by facility computer server 320 of Central Kitchen Facility 300. Facility computer server 320 directs the sorting system 340 to first aggregate all of the food items 114 included in a specific order 110, and then directs the completed order 110 to an order-loading zone in the Central Kitchen Facility 300.

Facility computer servers 320 of Central Kitchen Facilities 300 continually monitor the requested delivery locations 116 for all their pending orders 110 and use a Delivery Optimizing Algorithm to group orders 110 that are ready for loading so that they can be delivered by a single delivery vehicle 40 on a multi-leg trip. When a delivery vehicle 40 reaches the order loading zone in a Central Kitchen Facility 300, the delivery vehicle 40 is loaded with one or more food orders 110 and is given the food order IDs 111 and delivery location(s) 116 for the one or more orders 110. If a delivery vehicle 40 is loaded with multiple food orders 110, the food orders 110 are delivered in a given sequential order along a given route determined by the Delivery Optimizing Algorithm.

VRS 1 may also include Food Delivery Equipment 400 installed on delivery vehicles 40. Food Delivery Equipment 400 may include Delivery Control System 410 in communication with facility computer servers 320 of Central Kitchen Facilities 300 and Computer Ordering System 100 via communication links that are established by means of suitable communication protocols (e.g., BLUETOOTH®, WI-FI®, ZIGBEE®, Ethernet, SAP®, SAS®, ATP, GSM, TCP/IP, etc.) and are, at least in part, established wirelessly. Delivery Control System 410 of a delivery vehicle 40 may be in communication with facility computer servers 320 of Central Kitchen Facilities 300 and Computer Ordering System 100 to be called to a selected Central Kitchen Facility 300 to be loaded with one or more food orders 110, to receive food order information 112 (e.g., requested delivery location 116 and food order ID 111) and to transmit vehicle location information 404 and food order delivery status 402.

Preferably, a specialized VRS delivery vehicle 40 is used to provide thermally controlled storage of a food order 110 during delivery. Alternatively, third-party delivery vehicles may be used, but priority is given to delivery vehicles 40 that possess active thermally stabilized delivery capability. Food Delivery Equipment 400 installed on a delivery vehicle 40 may include a temperature controlled storage system 420 with a plurality of compartments 422 that may be accessible from either the interior or exterior of the delivery vehicle 40. Each storage compartment may be fitted with thermal insulation and heating and/or cooling capability, or in the alternative, may be configured without temperature control for items that do not require it. Uniquely, temperature controlled storage system 420 may simultaneously use both thermal sides of a heating/cooling thermal unit 424, such as, e.g., Peltier thermo-electric modules, vapor-compression refrigeration units, or other unitized methods of thermal modification. Traditionally, one side of a thermal unit 424 is used to shed heat (in the case of a refrigeration unit), or absorb heat (in the case of a heat pump), without regard for the utilization of the other side. Temperature controlled storage system 420 simultaneously uses the “heat” side of a thermal unit 424 to keep designated compartments 422 above ambient temperature while simultaneously using the “cold” side of a thermal unit 424 to keep designated compartments 422 below ambient temperature. This novel design maximizes the energy efficiency of each thermal unit 424, while at the same time cutting in half the number of thermal units needed. As such, this unique design gives a battery powered vehicle a practical way to achieve an energy efficient means of providing simultaneous heating and cooling of multiple compartments.

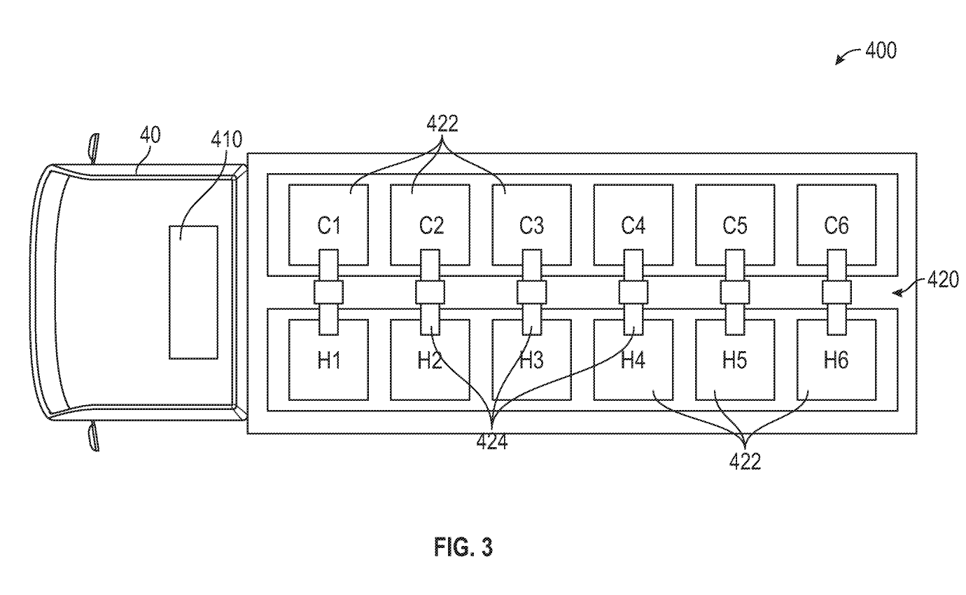

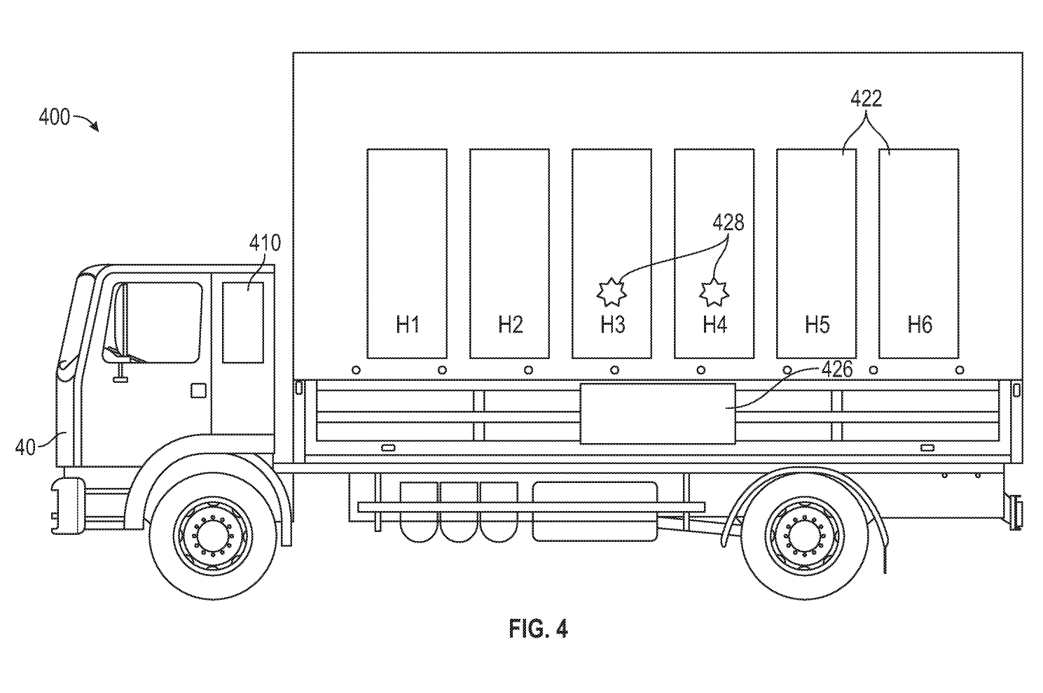

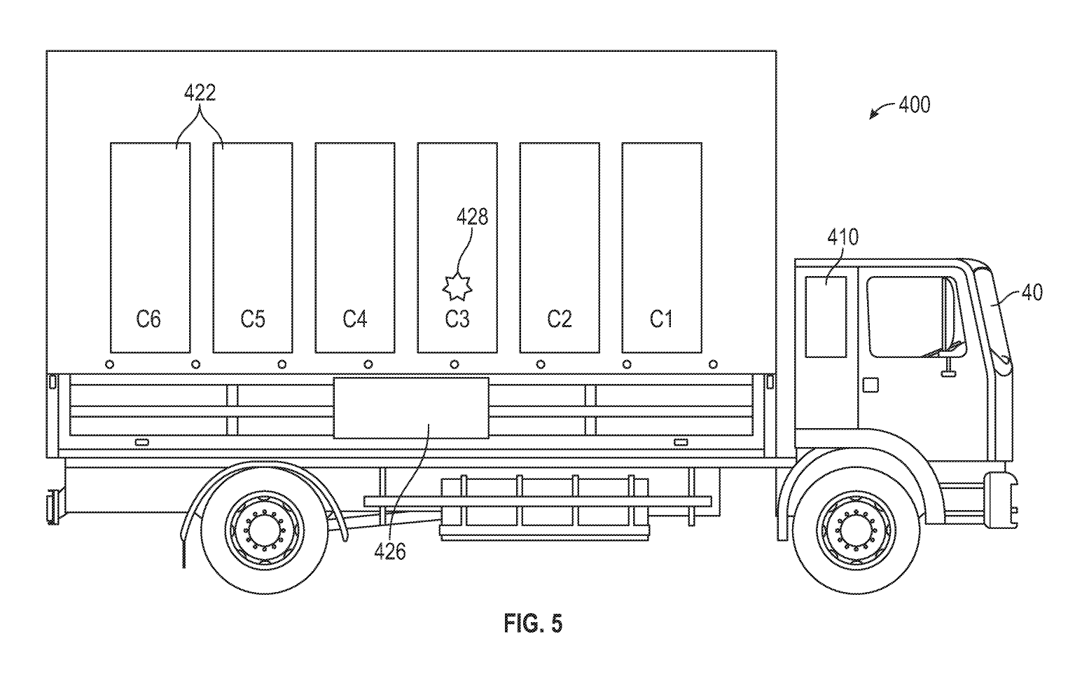

As shown in FIG. 3, in a preferred embodiment, temperature controlled storage system 420 simultaneously utilizes the opposing thermal outputs of heating/cooling thermal units 424, which are disposed between a plurality heated compartments H1-H6 and a plurality of cooled compartments C1-C6, which are aligned opposite each other. Typically, as shown in FIGS. 3-5, alike thermal compartments (e.g., H1-H6 or C1-C6) would be grouped together on one side of a vehicle adjacent to one another. Any number of different layout and design arrangements may be used, but all would share the unique configuration which would simultaneously direct the “cold” thermal outputs of thermal units 424 to the cold group of compartments C1-C6 in one area of the delivery vehicle 40 and would simultaneously direct the “hot” thermal outputs of thermal units 424 to the hot group of compartments H1-H6 in another area of the delivery vehicle 40. For example, individual Peltier modules 424 could share a pair of hot and cold compartments 422 on opposite sides of a delivery vehicle 40, or higher-output thermal units 424 would be configured to simultaneously supply multiple pairs of hot and cold compartments 422 in a centrally distributed manner as well. For compartments 422 that need to maintain freezing temperatures, higher output thermal modules 424 may be used to provide said freezing temperatures to the respective cooled compartments while simultaneously providing higher heating temperatures to the respective heated compartments.

In some embodiments, delivery vehicles 40 are autonomous vehicles (i.e., vehicles equipped with automated driving systems capable of performing all aspects of dynamic driving that can be managed by a human driver). The Food Delivery Equipment 400 for autonomous delivery vehicles 40 includes one or more externally mounted touch-screens 426. Upon arriving at the delivery location 116 for a food order 110, customer 10 is prompted to enter the order ID 111 via the one or more touch-screens 426. If the order ID 111 entered by customer 10 corresponds to an order 110 delivered by the delivery vehicle 40, then the compartments 422 containing the food items 114 corresponding to the order 110 are unlocked and identified on the one or more touch-screens 426 (e.g., by marked alphanumeric designation). Also, indicator lights 428 on the corresponding compartment doors 422 of the delivery vehicle 40 would be illuminated to direct the customer to the appropriate compartments 422 containing the food items 114 for the order 110.

Touch-screens 426 will prompt the customer 10 to confirm that all the food items 114 of the food order 110 have been retrieved from the storage compartments 422 of the autonomous delivery vehicle 40 by pressing an order acceptance button on the touch screens 426. In the event one or more compartments 422 that contain food items 114 for the food order 110 have not been opened at least once, a warning will be displayed on touch screens 426 or a message sent to computing device 20 or an audible announcement will be made to remind the customer 10 that their order 110 has not been completely retrieved from the delivery vehicle 40. Further, the autonomous delivery vehicle 40 would not be allowed to leave the premises until all the compartment doors 422 containing food items 114 for the food order 110 had been opened and the customer had confirmed that all the food items 114 for the food order 110 had been removed. Only then will the autonomous delivery vehicle 40 depart the delivery location. Additionally, Food Delivery Equipment 400 for autonomous delivery vehicles 40 may include an optional doorbell system interface module or other home access interface module that would allow Food Delivery Equipment 400 to interact with a doorbell system or other home access system to announce the arrival of food order delivery.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

What is claimed is:

1. A Virtual Restaurant System (VRS) for providing centralized food ordering, food preparation and food delivery simultaneously for various restaurants, comprising:
a plurality of central kitchen facilities;
wherein each of the central kitchen facilities is adapted to produce a specified menu of branded food items;
wherein each of the central kitchen facilities includes a plurality of branded kitchens;
wherein each of the branded kitchens in each of the central kitchen facilities produces a corresponding subset of branded food items in the specified menu; and
a Computerized Ordering System (COS) in communication with the central kitchen facilities and a plurality of VRS applications installed on remote computing devices;
wherein the COS receives a plurality of food orders via the VRS applications and assigns each of the food orders a unique food order ID;
wherein each of the food orders includes a delivery location and a selection of food items from the specified menu;
wherein, for each of the food orders, the COS selects one of the central kitchen facilities based on the delivery location;
wherein, for each of the food orders, the COS transmits the food order and its corresponding food order ID to the selected central kitchen facility;
wherein the selected central kitchen facility receives the food order and orders each of the selection of branded food items to be produced by its corresponding branded kitchen and labeled with the food order ID;
wherein the selected central kitchen facility sorts through the food produced by the kitchens and groups the food items belonging to the same food order together based on the labeled food order ID; and
wherein the selected central kitchen facility moves completed food orders to an order-loading zone where they can be loaded into delivery vehicles for delivery.

2. The VRS according to claim 1, wherein the selected central kitchen facility communicates to a delivery vehicle the delivery location and the food order ID for the food order to be delivered.

3. The VRS according to claim 1, wherein the selected central kitchen facility monitors the requested delivery locations of food orders and the number of available delivery vehicles waiting in a queue at the order-loading zone; and
wherein in order to balance the number of outstanding orders with the number of available delivery vehicles, the VRS uses a Delivery Optimizing Algorithm that will dynamically assign multiple sequential delivery stops to each delivery vehicle when necessary in order to optimize the delivery capability of each central kitchen facility at any given time.

4. The VRS according to claim 1, wherein the selected central kitchen facility monitors the requested delivery locations of completed food orders and uses a Delivery Optimizing Algorithm to group together multiple food orders that are ready for loading so that they can be delivered by a single delivery vehicle;
wherein the Delivery Optimizing Algorithm determines a sequential order and a delivery route for delivering the multiple food orders that are grouped together for delivery.

5. The VRS according to claim 4, wherein the selected central kitchen facility communicates to a delivery vehicle the sequential order and the delivery route for delivering the multiple food orders that are grouped together for delivery.

6. The VRS according to claim 1, wherein the COS sends a food order status notification via the VRS Application to notify a customer about the pending delivery of a completed food order.

7. The VRS according to claim 1, wherein the COS sends a food order verification via the VRS Application to verify that a customer is waiting at the delivery location for delivery of the food order.

8. The VRS according to claim 1, further comprising food delivery equipment installed on delivery vehicles;
wherein the food delivery equipment includes a temperature controlled storage system with a plurality of storage compartments and one or more heating/cooling thermal units; and
wherein both thermal sides of the one or more heating/cooling thermal units are used to refrigerate a first group of the plurality of storage compartments while simultaneously heating a second group of the plurality of storage compartments.

9. The VRS according to claim 1, further comprising food delivery equipment installed on delivery vehicles;
wherein the food delivery equipment includes a storage system with a plurality of storage compartments that are electronically locked/unlocked and monitored;
wherein the storage system electronically monitors whether storage compartments are storing food items for a food order;
wherein upon arrival at a delivery location associated with the food order, the storage system unlocks the storage compartments storing food items associated with the food order and monitors the opening of the unlocked storage compartments to ensure that the food items associated with the food order are retrieved.

10. The VRS according to claim 9, wherein the storage system provides a visual and/or audible alert that an unlocked storage compartment containing food items associated with the food order to be retrieved has not been opened.

11. The VRS according to claim 9, wherein each of the storage compartments includes an indicator light that is adapted to light up to indicate that the storage compartment is unlocked and contains food items associated with the food order to be retrieved.

12. The VRS according to claim 9, wherein each of the storage compartments has a storage compartment ID to facilitate loading and unloading of food items and to track storage and delivery of food items.

13. The VRS according to claim 1, further comprising food delivery equipment installed on delivery vehicles;
wherein the food delivery equipment includes a doorbell system interface module or other home access interface module configured to interact with a doorbell system or other home access system to announce the delivery of a food order.

14. The VRS according to claim 1, wherein the selected central kitchen facility utilizes a delivery vehicle loading system that directs unassigned delivery vehicles to sequentially pick up food orders for delivery contemporaneously with providing the delivery information to the delivery vehicles.

15. The VRS according to claim 1, wherein the selected central kitchen facility utilizes a delivery vehicle loading system that directs unassigned delivery vehicles to initially queue up in a line, but then sequentially directs individual delivery vehicles to individual loading ports in the order-loading zone to pick up food orders contemporaneously with providing delivery information for each orders to the delivery vehicles.

16. A method for providing centralized food ordering, food preparation and food delivery for various restaurants, comprising the steps of:
a Computer Ordering System (COS) communicating with a customer via a Virtual Restaurant System (VRS) application installed on a remote computing device;
the COS automatically receiving and/or requesting a customer location and/or a delivery location via the VRS application;
the COS delivering a selected menu/food order form via the VRS Application;
the COS receiving a food order via the VRS Application, the food order including food selections from the selected menu/food order, requested delivery location and requested delivery date/time;
the COS assigning a unique food order ID to the food order and transmitting the food order ID for the customer via the VRS Application;
the COS transmitting the food order and the food order ID to a central kitchen facility including a plurality of kitchens, where each of the plurality of kitchens produces different food items from the selected menu/food order form;
the selected central kitchen facility ordering each of the food selections from the food order to be produced by its corresponding kitchen and labeled with the food order ID;
the central kitchen facility sorting through the food items produced by the kitchens and grouping the food items belonging to the same food order together based on the labeled food order ID; and
the central kitchen facility moving the completed food order to an order-loading zone where it can be loaded into a delivery vehicle for delivery.

17. The method according to claim 16, wherein the selected menu/food order form is selected from a plurality of menu/food order forms;
wherein each of the plurality of menu/food order forms corresponds to a specific central kitchen facility with a defined service area; and
wherein the selected menu/food order form is selected based on whether the customer location and/or delivery location is located in the defined service area of the central kitchen facility.

18. The method according to claim 16, further comprising the step of:
the central kitchen facility communicating to the delivery vehicle the delivery location and the food order ID for the food order to be delivered.

19. The method according to claim 16, further comprising the step of:
the central kitchen facility monitoring the delivery locations of completed food orders and using a Delivery Optimizing Algorithm to group together multiple food orders that are ready for loading so that they can be delivered by a single delivery vehicle.

20. The method according to claim 19, further comprising the step of:
the Delivery Optimizing Algorithm determining a sequential order and a delivery route for delivering the multiple food orders that are grouped together for delivery.

21. The method according to claim 19, further comprising the step of:
the central kitchen facility communicating to the delivery vehicle the sequential order and the delivery route for delivering the multiple food orders that are grouped together for delivery.

22. The method according to claim 16, further comprising the step of:
the COS sending a food order status notification via the VRS Application to notify the customer about the pending delivery of a completed food order.

23. The method according to claim 16, further comprising the step of:
the COS sending a food order verification via the VRS Application to verify that the customer is waiting at the delivery location for delivery of the food order.
